(19) United States
(12) Patent Application Publication
(10) Pub. No.: US 2019/0252937 A1
(43) Pub. Date: Aug. 15, 2019

(54) STATOR AND MOTOR

(71) Applicant: Nidec Corporation, Kyoto (JP)

(72) Inventor: Keisuke FUKUNAGA, Kyoto (JP)

(21) Appl. No.: 16/315,172

(22) PCT Filed: Jul. 29, 2016
(86) PCT No.: PCT/JP2016/072267

§ 371 Date: Jan. 4, 2019

(51) Int. Cl. H02K 3/28; H02K 1/16; H02K 3/50; H02K 3/34; H02K 3/48; H02K 3/12

(52) U.S. Cl. CPC H02K 3/28; H02K 1/165; H02K 3/12; H02K 3/345; H02K 3/48; H02K 3/50

(57) ABSTRACT

An annular stator, a center of which is a central axis extending in an up-and-down direction, includes a stator core including teeth arrayed in a circumferential direction, and coils defined by a conducting wire wound on each of the teeth. The coils include coil groups in a U-phase, a V-phase, and a W-phase, and include connecting wires that relay the coils in the same phase. On each of upper and lower sides of the stator core, the connecting wire in one phase is in an area distant from the connecting wires in other phases in the circumferential direction.

### BACKGROUND OF THE INVENTION

### 1. Field of the Invention

The present disclosure relates to a stator and a motor.

### 2. Description of the Related Art

A brushless motor equipped with a columnar rotor and a stator having, at the center, space in which the rotor is placed is disclosed in Japanese Unexamined Patent Application Publication No. 2015-211587. The stator has an annular stator core and first to twelfth teeth that are sequentially provided in the circumferential direction on the inner circumferential side of the stator core. A conductor is wound on each of the first to twelfth teeth, forming first to twelfth coils. The first to twelfth coils each include a coil forming a U-phase, a coil forming V-phase, and a coil forming a W-phase.

Each phase has a connecting wire that connects two coils in the same phase together. The connecting wire in each phase is placed at the outer edge of one of both end faces of the stator core in the axial direction. The connecting wires in all phases are placed so as not to mutually intersect. Part of a plurality of connecting wires is superimposed when viewed from the axial direction. However, the connecting wires in all phases do not come into mutual contact by being placed at different positions in the axial direction.

As a method of avoiding the mutual contacts of the connecting wires, it is effective to change the height positions of the connecting wires in the axial direction as in Japanese Unexamined Patent Application Publication No. 2015-211587. In this method, however, there is the possibility that the thickness of the motor in the axial direction is increased. Moreover, if an insulating member such as an insulating tube is placed around the connecting wires to avoid the mutual contact of the connecting wires, there is the possibility that work loads in the manufacturing of the stator are increased.

### SUMMARY OF THE INVENTION

A stator according to an exemplary embodiment of the present disclosure is an annular stator, the center of which is a central axis extending in the up-and-down direction. The stator includes a stator core that includes a plurality of teeth arrayed in the circumferential direction. The stator also includes a plurality of coils with a conducting wire wound on each of the plurality of teeth. The plurality of coils include coil groups in three phases, which are a U-phase, a V-phase, and a W-phase, and also include connecting wires that relay the coils in the same phase. On each of the upper and lower sides of the stator core, the connecting wire in one phase is located in an area distant from the connecting wires in the other phases in the circumferential direction.

A motor according to an exemplary embodiment of the present disclosure includes an exemplary stator, described above, in the present disclosure and a rotor opposing the stator.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic cross-sectional view of a motor according an exemplary embodiment of the present disclosure.

FIG. 2 is a schematic plan view of a stator core that a stator according an exemplary embodiment of the present disclosure has.

FIG. 3 is a schematic plan view of the stator according an exemplary embodiment of the present disclosure.

FIG. 4 is a wiring diagram for a stator according to a first exemplary embodiment of the present disclosure.

FIG. 5 is a schematic diagram illustrating the connection structure of a plurality of coils included in the stator according to the first exemplary embodiment of the present disclosure.

FIG. 6 is a wiring diagram in a variation of the stator according to the first exemplary embodiment of the present disclosure.

FIG. 7 is a schematic diagram illustrating a variation of the connection structure of the plurality of coils included in the stator according to the first exemplary embodiment of the present disclosure.

FIG. 8 is a wiring diagram for a stator according to a second exemplary embodiment of the present disclosure.

FIG. 9 is a schematic diagram illustrating the connection structure of a plurality of coils included in the stator according to the second exemplary embodiment of the present disclosure.

FIG. 10 is a schematic diagram illustrating a variation of the connection structure of the plurality of coils included in the stator according to the second exemplary embodiment of the present disclosure.

### DETAILED DESCRIPTION OF THE PREFERRED EMBODIMENTS

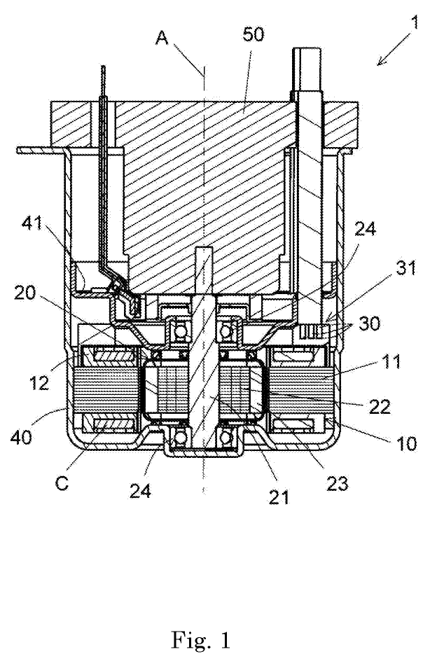

Exemplary embodiments of the present disclosure will be described in detail while the drawings are referenced. Incidentally, in this description, the direction in which the central axis A of the motor illustrated in FIG. 1 will be simply referred to as the “axial direction” and the radial direction and circumferential direction centered around the central axis A of the motor will be simply referred to as the “radial direction” and “circumferential direction”. Similarly, as for a stator as well, the directions matching the axial direction, radial direction, and circumferential direction of the motor in a state in which the stator is incorporated into the motor will be simply referred to as the “axial direction”, “radial direction”, and “circumferential direction”. In this description, the axial direction in a case in which the motor is placed in the direction indicated in FIG. 1 will be defined as the up-and-down direction. Incidentally, the up-and-down direction is a name used simply for explanation purposes and does not restrict actual positional relationships or directions.

FIG. 1 is a schematic cross-sectional view of a motor 1 according an embodiment of the present disclosure. The motor 1 is used in an electric brake booster. The motor 1 is a brushless motor. The motor 1 has a stator 10, a rotor 20, and a bus bar 30.

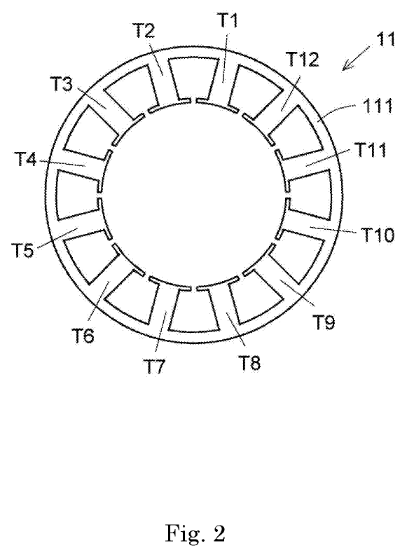

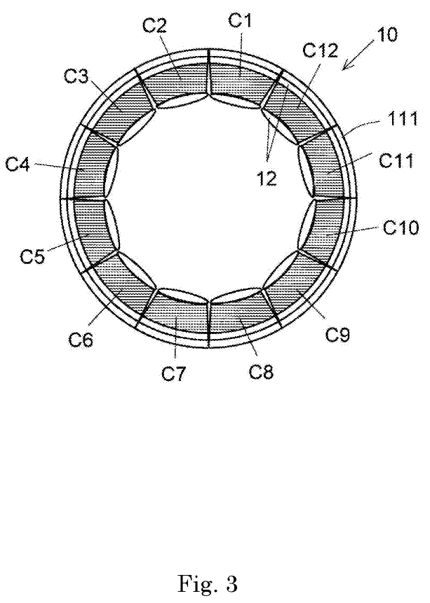

The stator 10 is annularly disposed around the central axis A extending in the up-and-down direction. The stator 10 has a stator core 11 and a plurality of coils C. FIG. 2 is a schematic plan view of the stator core 11 that the stator 10 according an embodiment of the present disclosure has. FIG. 3 is a schematic plan view of the stator 10 according an embodiment of the present disclosure.

As illustrated in FIG. 2, the stator core 11 has a plurality of teeth T placed in the circumferential direction. The stator core 11 has a core back 111 in a circular ring shape. The plurality of teeth T protrude from the core back 111 in the radial directions toward the inside. The stator core 11 is formed by laminating a plurality of magnetic steel plates in the axial direction. However, the stator core 11 may be formed from, for example, one member or may be formed by combining a plurality of members. As illustrated in FIG. 3, the plurality of coils C are formed by winding a conducting wire on each of the plurality of teeth T. To be more specific, the stator 10 has an insulator 12 that cover the plurality of teeth T as illustrated in FIG. 1 and FIG. 3. The insulator 12 is, for example, an insulating member such as, for example, a resin. The coils C are formed by winding conducting wires on the teeth T through the insulator 12.

In this embodiment, the stator core 11 has first to twelfth teeth T1 to T12 that are sequentially placed in the circumferential direction. That is, the number of teeth T is 12. The first to twelfth teeth T1 to T12 are placed at equal intervals in the circumferential direction. The stator 10 has first to twelfth coils C1 to C12 with a conducting wire wound on each of the first to twelfth teeth T1 to T12. That is, the number of coils C is 12.

The rotor 20 faces the stator 10. To be more specific, the outer circumferential surface of the rotor 20 faces the inner circumferential surface of the stator 10. The rotor 20 rotates around the central axis A. The rotor 20 has a columnar shaft 21, a cylindrical rotor core 22, and a magnet 23. The shaft 21 extends along the central axis A. The rotor core 22 is placed on the outer side of the shaft 21 in the radial direction. The rotor core 22 is formed by, for example, laminating a plurality of magnetic steel plates. The magnet 23 is fixed to the outer circumferential surface of the rotor core 22. The shaft 21 is rotatably supported by bearings 24 placed on the upper and lower sides of the rotor core 22.

The bus bar 30 is electrically connected to the rotor 20. Lead wires led from the coils C are connected to the bus bar 30. In this embodiment, by insert molding, for example, the bus bar 30 is held by an insulative resin. A bus bar unit 31 formed from the insulative resin and bus bar 30 is provided in a substantially circular ring shape and is placed on the upper side of the stator 10. By providing the bus bar 30, it is possible to prevent connection processing on lead wires led from the coils C from becoming complex. Details of a relationship between the coils C and the bus bar 30 will be described later.

The motor 1 further has a housing 40, which is substantially cylindrical, extends in the axial direction, and has a bottom. The housing 40 is placed on the more outer side in the radial directions than is the stator 10 and encloses the stator 10. Of the two bearings 24, the bearing 24 on the lower side is fixed to the central portion of the bottom wall of the housing 40. The bearing 24 on the upper side is fixed to the central portion of an inner lid 41 placed in the housing 40.

Incidentally, a plunger 50 formed from a gear is placed on the inner lid 41. The rotational motion of the motor 1 is converted to linear motion by the plunger 50, which presses a piston (not illustrated), generating a negative pressure needed for braking.

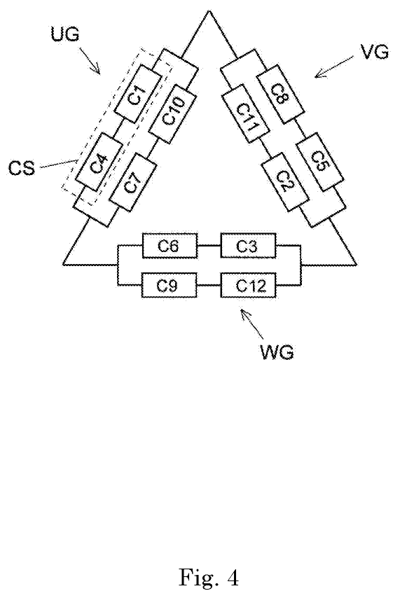

FIG. 4 is a wiring diagram for the stator 10 according to a first embodiment of the present disclosure. In the stator 10, a plurality of coils C are delta-connected as illustrated in FIG. 4. The plurality of coils C have coil groups UG, VG, and WG in three phases, which are a U-phase, a V-phase, and a W-phase. In this embodiment, the first coil C1, fourth coil C4, seventh coil C7, and tenth coil C10 constitute the U-phase coil group UG, the second coil C2, fifth coil C5, eighth coil C8, and eleventh coil C11 constitute the V-phase coil group VG, and the third coil C3, sixth coil C6, ninth coil C9, and twelfth coil C12 constitute the W-phase coil group WG.

In the stator 10, the coils C in three phases are placed in the circumferential direction in the order of the U-phase, V-phase and W-phase. Each of the coil groups UG, VG, and WG in three phases has coil pairs CS, in each of which two coils C are connected in series. In this embodiment, the stator 10 has six coil pairs CS. Each of the coil groups UG, VG, and WG has two coil pairs CS. Each of the coil groups UG, VG, and WG in three phases has a structure in which two coil pairs CS are connected in parallel. Since, in the structure in this embodiment, the number of coils C is 12 and the coils C are repeatedly placed in the circumferential direction in the order of the U-phase, V-phase and W-phase, the magnetism of the motor 1 can be well-balanced and the efficient motor 1 can be manufactured.

To be more specific, in the U-phase coil group UG, the first coil C1 and fourth coil C4 form a coil pair CS and the seventh coil C7 and tenth coil C10 form a coil pair CS. In these two coil pairs CS, the first coil C1 and tenth coil C10 are electrically connected in parallel and the fourth coil C4 and seventh coil C7 are electrically connected in parallel.

In the V-phase coil group VG, the second coil C2, and eleventh coil C11 form a coil pair CS and the fifth coil C5 and eighth coil C8 form a coil pair CS. In these two coil pairs CS, the second coil C2, and fifth coil C5 are electrically connected in parallel and the eighth coil C8 and eleventh coil C11 are electrically connected in parallel.

In the W-phase coil group WG, the third coil C3 and sixth coil C6 form a coil pair CS and the ninth coil C9 and twelfth coil C12 form a coil pair CS. In these two coil pairs CS, the third coil C3 and twelfth coil C12 are electrically connected in parallel and the sixth coil C6 and ninth coil C9 are electrically connected in parallel.

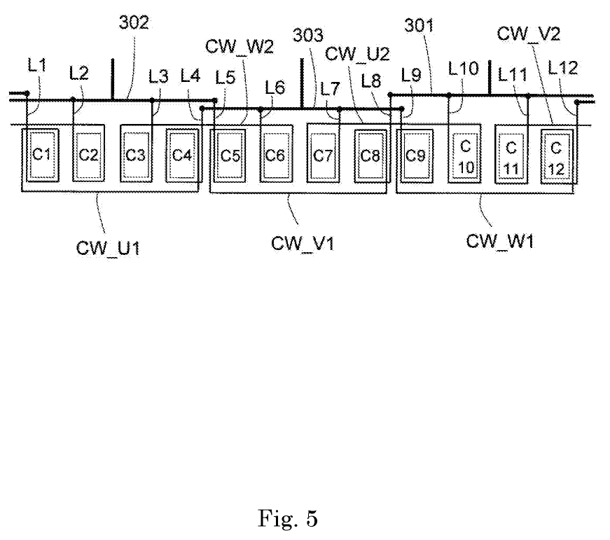

FIG. 5 is a schematic diagram illustrating the connection structure of a plurality of coils C that the stator 10 according to the first embodiment of the present disclosure has. The left-and-right direction in FIG. 5 corresponds to the circumferential direction. The plurality of coils C are all formed by winding a conducting wire in the same direction. In this embodiment, with all of the plurality of coils C, a conducting wire is wound counterclockwise. With the plurality of coils C, however, a conducting wire may be wound clockwise. The conducting wire is wound on, for example, a stator in a circular ring shape. However, the conducting wire may be wound on a linear stator, after which a stator in a circular ring shape may be formed. Alternatively, the conducting wire may be wound on a plurality of divided core elements, after which a stator in a circular ring shape may be formed. The plurality of coils C have connecting wires CW that relay coils C in the same phase. In this embodiment, two coils C constituting one coil pair CS are formed from one conducting wire. Therefore, one connecting wire CW is present for each coil pair CS. In this embodiment, six connecting wires CW are present.

A pair of the first coil C1 and fourth coil C4, which are connected in series, has a first U-phase connecting wire CW_U1, a first lead wire L1, and a fourth lead wire L4. The first U-phase connecting wire CW_U1 is placed on one of the upper and lower sides of the stator core 11 and relays both coils C1 and C4. In this embodiment, the first U-phase connecting wire CW_U1 is placed on the lower side of the stator core 11. The first U-phase connecting wire CW_U1 is placed along, for example, the outer circumferential surface of the insulator 12 in the radial direction. The first U-phase connecting wire CW_U1 may be supported by part of the insulator 12. The first lead wire L1 is led from the first coil C1. The fourth lead wire L4 is led from the fourth coil C4.

A pair of the seventh coil C7 and tenth coil C10, which are connected in series, has a second U-phase connecting wire CW_U2, a seventh lead wire L7, and a tenth lead wire L10. The second U-phase connecting wire CW_U2 is placed on the other of the upper and lower sides of the stator core 11 and relays both coils C7 and C10. In this embodiment, the second U-phase connecting wire CW_U2 is placed on the upper side of the stator core 11. The second U-phase connecting wire CW_U2 is placed along, for example, the outer circumferential surface of the insulator 12 in the radial direction. The second U-phase connecting wire CW_U2 may be supported by part of the insulator 12. The seventh lead wire L7 is led from the seventh coil C7. The tenth lead wire L10 is led from the tenth coil C10.

A pair of the fifth coil C5 and eighth coil C8, which are connected in series, has a first V-phase connecting wire CW_V1, a fifth lead wire L5, and an eighth lead wire L8. The first V-phase connecting wire CW_V1 is placed on one of the upper and lower sides of the stator core 11 and relays both coils C5 and C8. In this embodiment, the first V-phase connecting wire CW_V1 is placed on the lower side of the stator core 11. The first V-phase connecting wire CW_V1 is placed along, for example, the outer circumferential surface of the insulator 12 in the radial direction. The first V-phase connecting wire CW_V1 may be supported by part of the insulator 12. The fifth lead wire L5 is led from the fifth coil C5. The eighth lead wire L8 is led from the eighth coil C8.

A pair of the second coil C2, and eleventh coil C11, which are connected in series, has a second V-phase connecting wire CW_V2, a second lead wire L2, and an eleventh lead wire L11. The second V-phase connecting wire CW_V2 is placed on the other of the upper and lower sides of the stator core 11 and relays both coils C2 and C11. In this embodiment, the second V-phase connecting wire CW_V2 is placed on the upper side of the stator core 11. The second V-phase connecting wire CW_V2 is placed along, for example, the outer circumferential surface of the insulator 12 in the radial direction. The second V-phase connecting wire CW_V2 may be supported by part of the insulator 12. The second lead wire L2 is led from the second coil C2. The eleventh lead wire L11 is led from the eleventh coil C11.

A pair of the ninth coil C9 and twelfth coil C12, which are connected in series, has a first W-phase connecting wire CW_W1, a ninth lead wire L9, and a twelfth lead wire L12. The first W-phase connecting wire CW_W1 is placed on one of the upper and lower sides of the stator core 11 and relays both coils C9 and C12. In this embodiment, the first W-phase connecting wire CW_W1 is placed on the lower side of the stator core 11. The first W-phase connecting wire CW_W1 is placed along, for example, the outer circumferential surface of the insulator 12 in the radial direction. The first W-phase connecting wire CW_W1 may be supported by part of the insulator 12. The ninth lead wire L9 is led from the ninth coil C9. The twelfth lead wire L12 is led from the twelfth coil C12.

A pair of the third coil C3 and sixth coil C6, which are connected in series, has a second W-phase connecting wire CW_W2, a third lead wire L3, and a sixth lead wire L6. The second W-phase connecting wire CW_W2 is placed on the other of the upper and lower sides of the stator core 11 and relays both coils C3 and C6. In this embodiment, the second W-phase connecting wire CW_W2 is placed on the upper side of the stator core 11. The second W-phase connecting wire CW_W2 is placed along, for example, the outer circumferential surface of the insulator 12 in the radial direction. The second W-phase connecting wire CW_W2 may be supported by part of the insulator 12. The third lead wire L3 is led from the third coil C3. The sixth lead wire L6 is led from the sixth coil C6.

In this embodiment, on the lower side of the stator core 11, the first U-phase connecting wire CW_U1, first V-phase connecting wire CW_V1, and first W-phase connecting wire CW_W1 are placed in mutually distant areas in the circumferential direction. Moreover, on the upper side of the stator core 11, the second U-phase connecting wire CW_U2, second V-phase connecting wire CW_V2, and second W-phase connecting wire CW_W2 are placed in mutually distant areas in the circumferential direction. That is, on each of the upper and lower sides of the stator core 11, the connecting wire CW in one phase is placed in an area distant from the connecting wires CW in the other phases in the circumferential direction. The connecting wire CW in one phase does not overlap the connecting wires CW in the other phases in the circumferential direction.

In the stator 10, the connecting wires CW in three phases do not overlap one another in the circumferential direction on the upper and lower sides of the stator core 11, so the possibility that mutual contacts of connecting wires CW occur can be reduced. Therefore, the use of a part, such as an insulating tube, to assure insulation of the connecting wires CW can be eliminated. Moreover, the position in the up-and-down direction at which the connecting wire CW in each phase is disposed does not need to be shifted to avoid mutual contacts of the connecting wires CW, so the stator 10 and motor 1 can be downsized. According to the structure in this embodiment, since the placement of the connecting wires CW can be simplified, the use of an automated line is possible. According to the structure in this embodiment, since conducting wires can be easily wound on the stator core 11, the manufacturing cost can be reduced. Incidentally, the connecting wires CW may be placed at the outer edge of the stator 10 on the outer side in the radial direction or may be placed at the inner edge on the inner side in the radial direction. Moreover, the connecting wires CW may be placed on one of both end faces of the stator 10 in the axial direction.

Lead wires L led from the plurality of coils C in the up-and-down direction are all led in the same direction. In this embodiment, the first to twelfth lead wires L1 to L12 led in the up-and-down direction are all led in the same direction. To be more specific, the first to twelfth lead wires L1 to L12 are all led upward. In this structure, the whole of the bus bar 30, which connects lead wires L, can be placed on one of the upper and lower sides of the stator core 11. In this embodiment, the whole of the bus bar 30 is placed on the upper side of the stator core 11.

To be more specific, the bus bar 30 has a first bus bar 301, a second bus bar 302, and a third bus bar 303. The first bus bar 301 is connected to the first lead wire L1, eighth lead wire L8, tenth lead wire L10, and eleventh lead wire L11. The second bus bar 302 is connected to the second lead wire L2, third lead wire L3, fifth lead wire L5, and twelfth lead wire L12. The third bus bar 303 is connected to the fourth lead wire L4, sixth lead wire L6, seventh lead wire L7, and ninth lead wire L9. Thus, the first to twelfth coils C1 to C12 are delta-connected. The first bus bar 301, second bus bar 302, and third bus bar 303 are held in the bus bar unit 31 without being electrically connected mutually. In this embodiment, the first bus bar 301, second bus bar 302, and third bus bar 303 are held in the bus bar unit 31 in a state in which their positions in the radial direction are mutually shifted.

In this embodiment, in each coil pair CS, the connecting wire CW connects the outer sides, in the circumferential direction, of two coils C placed in the circumferential direction. This structure holds for all the six coil pairs CS. When this structure is taken, it is possible to form each coil C easily in a state in which tension is applied to the conducting wire and to reduce the possibility that, after the coil C has been formed, the lead wire slackens.

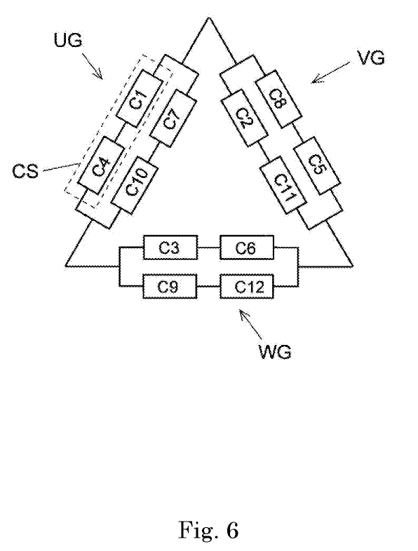

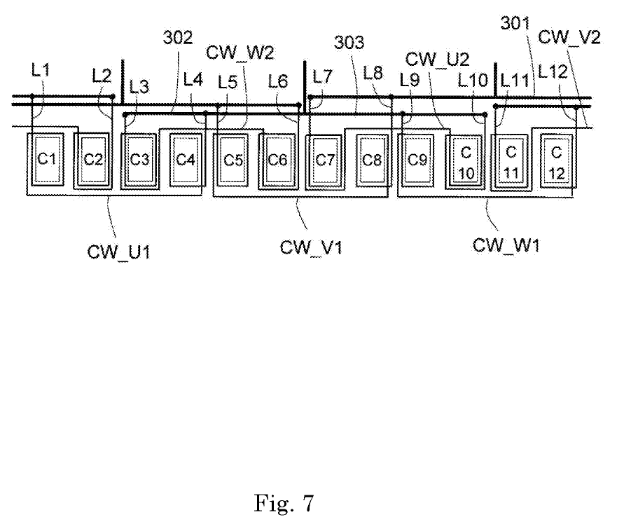

FIG. 6 is a wiring diagram in a variation of the stator 10 according to the first embodiment of the present disclosure. FIG. 7 is a schematic diagram illustrating a variation of the connection structure of the plurality of coils C that the stator 10 according to the first embodiment of the present disclosure has. The left-and-right direction in FIG. 7 corresponds to the circumferential direction. In the variations illustrated in FIG. 6 and FIG. 7 as well, a plurality of coils C are delta-connected. Although the connection structures in the variations illustrated in FIG. 6 and FIG. 7 are substantially the same as the structures in the first embodiment described above, part of the structures differs. The following description will focus on different portions.

In the U-phase coil group UG, the first coil C1 and fourth coil C4 form a coil pair CS and the seventh coil C7 and tenth coil C10 form a coil pair CS. This point is the same as the structure in the first embodiment described above. In these two coil pairs CS, however, the first coil C1 and seventh coil C7 are electrically connected and the fourth coil C4 and tenth coil C10 are electrically connected, forming a parallel connection. That is, the way of forming a parallel connection differs from the structure in the first embodiment described above.

In the V-phase coil group VG, the second coil C2, and eleventh coil C11 form a coil pair CS and the fifth coil C5 and eighth coil C8 form a coil pair CS. This point is the same as the structure in the first embodiment described above. In these two coil pairs CS, however, the second coil C2 and eighth coil C8 are electrically connected and the fifth coil C5 and eleventh coil C11 are electrically connected, forming a parallel connection. That is, the way of forming a parallel connection differs from the structure in the first embodiment described above.

In the W-phase coil group WG, the third coil C3 and sixth coil C6 form a coil pair CS and the ninth coil C9 and twelfth coil C12 form a coil pair CS. This point is the same as the structure in the first embodiment described above. In these two coil pairs CS, however, the third coil C3 and ninth coil C9 are electrically connected and the sixth coil C6 and twelfth coil C12 are electrically connected, forming a parallel connection. That is, the way of forming a parallel connection differs from the structure in the first embodiment described above.

As illustrated in FIG. 7, the first to twelfth lead wires L1 to L12 are all led upward. This is the same as the structure in the first embodiment described above. However, a connection of the first bus bar 301, second bus bar 302, and third bus bar 303 in the bus bar 30 to which the first to twelfth lead wires L1 to L12 are connected differs from the structure in the first embodiment described above. The first bus bar 301 is connected to the first lead wire L1, second lead wire L2, seventh lead wire L7, and eighth lead wire L8. The second bus bar 302 is connected to the fifth lead wire L5, sixth lead wire L6, eleventh lead wire L11, and twelfth lead wire L12. The third bus bar 303 is connected to the third lead wire L3, fourth lead wire L4, ninth lead wire L9, and tenth lead wire L10.

In a coil pair of the second coil C2 and eleventh coil C11, a coil pair of the third coil C3 and sixth coil C6, and a coil pair of the seventh coil C7 and tenth coil C10, the connecting wire CW connects the inner sides, in the circumferential direction, of the two coils C placed in the circumferential direction in the circumferential direction. That is, in the variation, some coil pairs CS do not have a structure in which the connecting wire CW connects the outer sides, in the circumferential direction, of two coils C placed in the circumferential direction. This point differs from the structure in the first embodiment described above.

In the structure in the variation as well, on the upper and lower sides of the stator core 11, the connecting wire CW in one phase is placed in an area distant from the connecting wires CW in the other phases in the circumferential direction. That is, the connecting wires CW in three phases do not overlap one another in the circumferential direction on the upper and lower sides of the stator core 11, so the possibility that mutual contacts of connecting wires CW occur can be reduced. Therefore, the use of a part, such as an insulating tube, to assure insulation of the connecting wires CW can be eliminated. Moreover, the position in the up-and-down direction at which the connecting wire CW in each phase is disposed does not need to be shifted to avoid mutual contacts of the connecting wires CW, so the stator 10 and motor 1 can be downsized. Also, since the lead wires L are all led upward, the whole of the bus bar 30 can be placed on the upper side of the stator core 11.

In descriptions of the connection structure of coils in the second embodiment, descriptions overlapping the first embodiment will be omitted when the descriptions are not required.

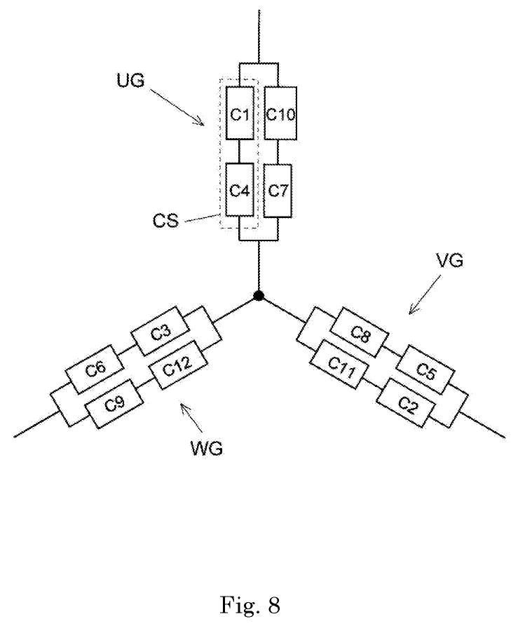

FIG. 8 is a wiring diagram for the stator 10 according to a second embodiment of the present disclosure. As illustrated in FIG. 8, in the stator 10, a plurality of coils C are star-connected. The plurality of coils C have coil groups UG, VG, and WG in three phases, which are the U-phase, V-phase, and W-phase. Coils C constituting the coil group UG, VG, or WG in each phase are the same as in the first embodiment. Moreover, the combination of coils C constituting one coil pair CS is also the same as in the first embodiment. Furthermore, a structure in which coil pairs CS are connected in parallel is also the same as in the first embodiment. Detailed descriptions of these will be omitted.

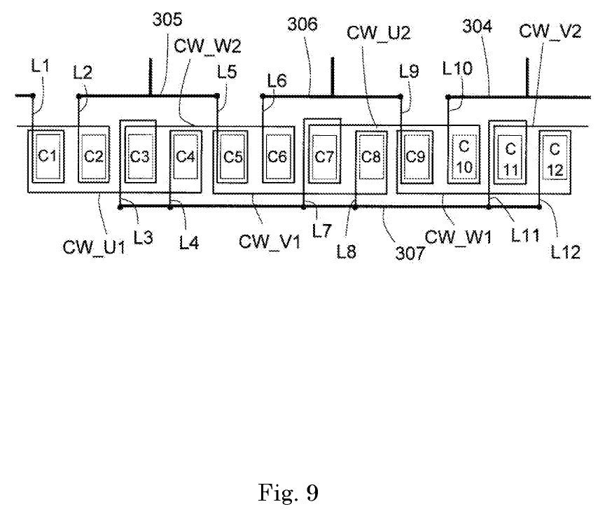

FIG. 9 is a schematic diagram illustrating the connection structure of a plurality of coils C that the stator 10 according to the second embodiment of the present disclosure has. The left-and-right direction in FIG. 9 corresponds to the circumferential direction. The plurality of coils C are all formed by winding a conducting wire in the same direction as in the first embodiment. In this embodiment, with all of the plurality of coils C, a conducting wire is wound counterclockwise. Each coil pair CS has the same connecting wires CW and lead wires L as in the first embodiment. Detailed descriptions of these will be omitted. However, a direction in which the lead wire L is led from each coil pair CS and the structure of the bus bar 30 to which each lead wire L is connected differ. These different points will be described below.

In the second embodiment, of the lead wires L led from the plurality of coils C in the up-and-down direction, a lead wire connected to a neutral point and other lead wires are led in opposite directions. To be more specific, of the first to twelfth lead wires L1 to L12 led in the up-and-down direction, the first, second, fifth, sixth, ninth, and tenth lead wires and the third, fourth, seventh, eighth, eleventh, and twelfth lead wires are led in opposite directions. In this embodiment, the first, second, fifth, sixth, ninth, and tenth lead wires are led upward. The third, fourth, seventh, eighth, eleventh, and twelfth lead wires are led downward.

In the second embodiment, the bus bar 30 has a first bus bar 304, a second bus bar 305, a third bus bar 306, and a fourth bus bar 307. The first bus bar 304 is connected to the first lead wire L1 and tenth lead wire L10. The second bus bar 305 is connected to the second lead wire L2 and fifth lead wire L5. The third bus bar 306 is connected to the sixth lead wire L6 and ninth lead wire L9. The fourth bus bar 307 is connected to the third, fourth, seventh, eighth, eleventh, and twelfth lead wires L3, L4, L7, L8, L11, and L12. The fourth bus bar 307 is a bus bar intended for a neutral point. Thus, the first to twelfth coils C1 to C12 are star-connected. The first, second, and third bus bars 304 to 306 are held in the bus bar unit 31, which is placed on the upper side of the stator core 11, without being electrically connected mutually. In this embodiment, three bus bars, 304 to 306, are held in the bus bar unit 31 in a state in which their positions in the radial direction are mutually shifted. The fourth bus bar 307 is placed on the lower side of the stator core 11. The fourth bus bar 307 may also be supported by a resin.

In the structure in the second embodiment as well, on the upper and lower sides of the stator core 11, the connecting wire CW in one phase is placed in an area distant from the connecting wires CW in the other phases in the circumferential direction. That is, the connecting wires CW in three phases do not overlap one another in the circumferential direction on the upper and lower sides of the stator core 11, so the possibility that mutual contacts of connecting wires CW occur can be reduced. Moreover, in all coil pairs CS, the connecting wire CW connects the outer sides, in the circumferential direction, of two coils C placed in the circumferential direction. Therefore, it is possible to form each coil C easily in a state in which tension is applied to the conducting wire and to reduce the possibility that, after the coil C has been formed, the lead wire slackens.

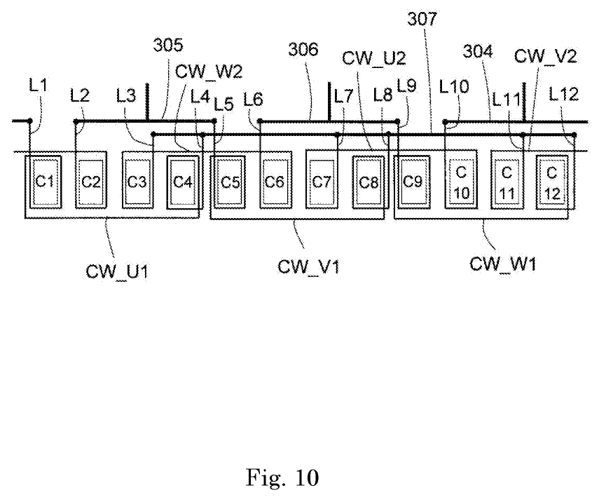

FIG. 10 is a schematic diagram illustrating a variation of the connection structure of the plurality of coils C that the stator 10 according to the second embodiment of the present disclosure has. The left-and-right direction in FIG. 10 corresponds to the circumferential direction. Although the connection structure of the coil C in the variation is substantially the same as the structure in the second embodiment described above, part of the structure differs. The following description will focus on different portions.

In the variation illustrated in FIG. 10, lead wires L led from the plurality of coils C in the up-and-down direction are all led in the same direction. To be more specific, the first to twelfth lead wires L1 to L12 led in the up-and-down direction are all led in the same direction. In this embodiment, the first to twelfth lead wires L1 to L12 are all led upward. This point differs from the structure in the second embodiment described above. In the structure in the variation, due to the structural difference, the whole of the bus bar 30, which connects lead wires L, can be placed on one of the upper and lower sides of the stator core 11.

Incidentally, in the structure in the variation, since the fourth bus bar 307 is also placed on the upper side of the stator core 11, the fourth bus bar 307 is also held in the bus bar unit 31. The first, second, third, and fourth bas bars 304 to 307 are held in the bus bar unit 31, without being electrically connected mutually.

In the structure in the variation as well, the connecting wires CW in three phases do not overlap one another in the circumferential direction on the upper and lower sides of the stator core 11, so the possibility that mutual contacts of connecting wires CW occur can be reduced. Moreover, in all coil pairs CS, the connecting wire CW connects the outer sides, in the circumferential direction, of two coils C placed in the circumferential direction. Therefore, it is possible to form each coil C easily in a state in which tension is applied to the conducting wire and to reduce the possibility that, after the coil C has been formed, the lead wire slackens.

The structures in the embodiments indicated above are merely exemplary of the present disclosure. The structures in the embodiments may be appropriately changed within a range not exceeding the technical concept of the present disclosure. It is also possible to practice a plurality of embodiments, variations in each embodiment, and the like by combining them to the extent possible.

So far, a case has been indicated in which the motor and stator core in the present disclosure are applied to an electric brake booster. However, this is merely exemplary. The present disclosure can be widely applied to, for example, an electric power steering apparatus, a pump, an antilock braking system, and other applications.

The present disclosure can be widely applied to motors used in, for example, home electrical appliances, automobiles, ships, aircraft, trains, and the like.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-11. (canceled)

12. An annular stator, a center of which is a central axis extending in an up-and-down direction, the stator comprising:
a stator core including a plurality of teeth arrayed in a circumferential direction; and
a plurality of coils with a conducting wire wound on each of the plurality of teeth; wherein
the plurality of coils include:
coil groups in three phases, which are a U-phase, a V-phase, and a W-phase; and
connecting wires that relay the coils in a same phase; and
on each of an upper side and a lower side of the stator core, the connecting wire in one phase is in an area distant from the connecting wires in other phases in the circumferential direction.

13. The stator according to claim 12, wherein
each of the coil groups in the three phases includes a coil pair in which two coils are connected in series; and
in the coil pair, the connecting wire connects outer sides, in the circumferential direction, of two coils in the circumferential direction.

14. The stator according to claim 12, wherein
a number of the teeth and a number of the coils are 12;
each of the coil groups in the three phases includes a structure in which two coil pairs, in each of which two coils are connected in series, are connected in parallel; and
the coils in the three phases are arrayed in the circumferential direction in an order of the U-phase, the V-phase and the W-phase.

15. The stator according to claim 12, wherein
the plurality of coils are delta-connected; and
lead wires extending from the plurality of coils in the up-and-down direction all extend in a same direction.

16. The stator according to claim 12, wherein
the plurality of coils are star-connected; and
lead wires extending from the plurality of coils in the up-and-down direction all extend in a same direction.

17. The stator according to claim 12, wherein
the plurality of coils are star-connected; and
of the lead wires extending from the plurality of coils in the up-and-down direction, a lead wire connected to a neutral point and other lead wires extend in opposite directions.

18. A motor comprising:
the stator according to claim 12; and
a rotor opposing the stator.

19. The motor according to claim 18, further comprising a bus bar that connects the lead wires extending from the coils.

20. A motor comprising:
an annular stator, a center of which is a central axis extending in an up-and-down direction;
a rotor opposing the stator; and
a bus bar electrically connected to the stator; wherein the stator includes:
a stator core including first to twelfth teeth sequentially arrayed in a circumferential direction; and
first to twelfth coils with a conducting wire wound on each of the first to twelfth teeth;
the first coil, fourth coil, seventh coil, and tenth coil define a U-phase coil group;
the second coil, fifth coil, eighth coil, and eleventh coil define a V-phase coil group;
the third coil, sixth coil, ninth coil, and twelfth coil define a W-phase coil group;
a pair of the first coil and the fourth coil, which are connected in series, includes:
a first U-phase connecting wire that is located on one of upper and lower sides of the stator core and relays both coils;
a first lead wire extended from the first coil; and
a fourth lead wire extended from the fourth coil;
a pair of the seventh coil and the tenth coil, which are connected in series, includes:
a second U-phase connecting wire that is located on another of the upper and lower sides of the stator core and relays both coils;
a seventh lead wire extended from the seventh coil; and
a tenth lead wire extended from the tenth coil;
a pair of the fifth coil and the eighth coil, which are connected in series, includes:
a first V-phase connecting wire that is located on the one of the upper and lower sides of the stator core and relays both coils;
a fifth lead wire extended from the fifth coil; and
an eighth lead wire extended from the eighth coil;
a pair of the second coil and the eleventh coil, which are connected in series, includes:
a second V-phase connecting wire that is located on the another of the upper and lower sides of the stator core and relays both coils;
a second lead wire extended from the second coil; and
an eleventh lead wire extended from the eleventh coil;
a pair of the ninth coil and the twelfth coil, which are connected in series, includes:
a first W-phase connecting wire that is located on the one of the upper and lower sides of the stator core and relays both coils;
a ninth lead wire extended from the ninth coil; and
a twelfth lead wire extended from the twelfth coil;
a pair of the third coil and the sixth coil, which are connected in series, includes:
a second W-phase connecting wire that is located on the another of the upper and lower sides of the stator core and relays both coils;
a third lead wire extended from the third coil; and
a sixth lead wire extended from the sixth coil;
the first to twelfth lead wires extended in the up-and-down direction are all extended in the same direction; and
the bus bar includes:
a first bus bar connected to the first lead wire, the eighth lead wire, the tenth lead wire, and the eleventh lead wire;
a second bus bar connected to the second lead wire, the third lead wire, the fifth lead wire, and the twelfth lead wire; and
a third bus bar connected to the fourth lead wire, the sixth lead wire, the seventh lead wire, and the ninth lead wire.

21. A motor comprising:
an annular stator, a center of which is a central axis extending in an up-and-down direction;
a rotor opposing the stator; and
a bus bar electrically connected to the stator; wherein the stator includes:
a stator core including first to twelfth teeth sequentially arrayed in a circumferential direction; and
first to twelfth coils with a conducting wire wound on each of the first to twelfth teeth;
the first coil, fourth coil, seventh coil, and tenth coil define a U-phase coil group;
the second coil, fifth coil, eighth coil, and eleventh coil define a V-phase coil group;
the third coil, sixth coil, ninth coil, and twelfth coil define a W-phase coil group;
a pair of the first coil and the fourth coil, which are connected in series, includes:
a first U-phase connecting wire that is located on one of upper and lower sides of the stator core and relays both coils;
a first lead wire extended from the first coil; and
a fourth lead wire extended from the fourth coil;
a pair of the seventh coil and the tenth coil, which are connected in series, includes:
a second U-phase connecting wire that is located on another of the upper and lower sides of the stator core and relays both coils;
a seventh lead wire extended from the seventh coil; and
a tenth lead wire extended from the tenth coil;
a pair of the fifth coil and the eighth coil, which are connected in series, includes:
a first V-phase connecting wire that is located on the one of the upper and lower sides of the stator core and relays both coils;
a fifth lead wire extend from the fifth coil; and
an eighth lead wire extended from the eighth coil;
a pair of the second coil and the eleventh coil, which are connected in series, includes:
a second V-phase connecting wire that is located on the another of the upper and lower sides of the stator core and relays both coils;
a second lead wire extended from the second coil; and
an eleventh lead wire extended from the eleventh coil;
a pair of the ninth coil and the twelfth coil, which are connected in series, includes:
a first W-phase connecting wire that is located on the one of the upper and lower sides of the stator core and relays both coils;
a ninth lead wire extended from the ninth coil; and
a twelfth lead wire extended from the twelfth coil;
a pair of the third coil and the sixth coil, which are connected in series, includes:
a second W-phase connecting wire that is located on the another of the upper and lower sides of the stator core and relays both coils;
a third lead wire extended from the third coil; and
a sixth lead wire extended from the sixth coil;
of the first to twelfth lead wires extended in the up-and-down direction, the first, second, fifth, sixth, ninth, and tenth lead wires and the third, fourth, seventh, eighth, eleventh, and twelfth lead wires are extended in opposite directions, and
the bus bar includes:
a first bus bar connected to the first lead wire and the tenth lead wire;
a second bus bar connected to the second lead wire and the fifth lead wire,
a third bus bar connected to the sixth lead wire and the ninth lead wire; and
a fourth bus bar connected to the third, fourth, seventh, eighth, eleventh, and twelfth lead wires, the fourth bus bar being intended for a neutral point.

22. A motor comprising:
an annular stator, a center of which is a central axis extending in an up-and-down direction;
a rotor opposing the stator; and
a bus bar electrically connected to the stator; wherein
the stator includes:
a stator core including first to twelfth teeth sequentially arrayed in a circumferential direction; and
first to twelfth coils with a conducting wire wound on each of the first to twelfth teeth;
the first coil, fourth coil, seventh coil, and tenth coil define a U-phase coil group;
the second coil, fifth coil, eighth coil, and eleventh coil define a V-phase coil group;
the third coil, sixth coil, ninth coil, and twelfth coil define a W-phase coil group;
a pair of the first coil and the fourth coil, which are connected in series, includes:
a first U-phase connecting wire that is located on one of upper and lower sides of the stator core and relays both coils;
a first lead wire extended from the first coil; and
a fourth lead wire extended from the fourth coil;
a pair of the seventh coil and the tenth coil, which are connected in series, includes:
a second U-phase connecting wire that is located on another of the upper and lower sides of the stator core and relays both coils;
a seventh lead wire extended from the seventh coil; and
a tenth lead wire extended from the tenth coil;
a pair of the fifth coil and the eighth coil, which are connected in series, includes:
a first V-phase connecting wire that is located on the one of the upper and lower sides of the stator core and relays both coils;
a fifth lead wire extended from the fifth coil; and
an eighth lead wire extended from the eighth coil;
a pair of the second coil and the eleventh coil, which are connected in series, includes:
a second V-phase connecting wire that is located on the another of the upper and lower sides of the stator core and relays both coils;
a second lead wire extended from the second coil; and
an eleventh lead wire extended from the eleventh coil;
a pair of the ninth coil and the twelfth coil, which are connected in series, includes:
a first W-phase connecting wire that is located on the one of the upper and lower sides of the stator core and relays both coils;
a ninth lead wire extended from the ninth coil; and
a twelfth lead wire extended from the twelfth coil;
a pair of the third coil and the sixth coil, which are connected in series, includes:
a second W-phase connecting wire that is located on the another of the upper and lower sides of the stator core and relays both coils;
a third lead wire extended from the third coil; and
a sixth lead wire extended from the sixth coil;
the first to twelfth lead wires extended in the up-and-down direction are all extend in a same direction; and
the bus bar includes:
a first bus bar connected to the first lead wire and the tenth lead wire;
a second bus bar connected to the second lead wire and the fifth lead wire;
a third bus bar connected to the sixth lead wire and the ninth lead wire; and
a fourth bus bar connected to the third, fourth, seventh, eighth, eleventh, and twelfth lead wires, the fourth bus bar being intended for a neutral point.
